(19) United States
(12) Patent Application Publication
(10) Pub. No.: US 2001/0001581 A1
(43) Pub. Date: May 24, 2001

(54) CONFOCAL SCANNER

(75) Inventor: TAKEO TANAAMI, TOKYO (JP)

Correspondence Address: MOONRAY KOJIMA, BOX 627, WILLIAMSTOWN, MA, 01267

(73) Assignee: YOKOGAWA ELECTRIC CORPORATION

(21) Appl. No.: 09/432,322

(22) Filed: Nov. 2, 1999

(30) Foreign Application Priority Data
Nov. 17, 1998 (JP) 98/326,440

(51) Int. Cl. G02B 21/00

(52) U.S. Cl. 359/368

(57) ABSTRACT

A confocal scanner which synchronously rotates a first disk, having a plurality of focusing means, and a second disk, having a plurality of apertures of the same pattern as the focusing means, and scans a sample by focusing light beams passing through the focusing means and apertures; wherein the plurality of focusing means are arranged so that each border line between focusing means passes each bisected point of line segments connecting any two center points of adjacent focusing means thereby improving efficiency of light utilization.

### BACKGROUND OF THE INVENTION

1. Field of Invention

This invention relates to a confocal scanner that carries out optical scanning by rotating disks provided with a plurality of focusing means and apertures, respectively; and more particularly, to such confocal scanner which has improved light efficiency.

2. Description of the Prior Art

A confocal scanner carries out light scanning by rotating two disks provided with a plurality of focusing means and aperture, respectively. FIG. 1 is a block diagram depicting a conventional confocal scanner, such as disclosed in Japan Unexamined Patent Publication HEI 4-15411, which comprises a laser 1; disk 2 provided with micro lenses as a focusing means (called “micro lens disk”); beam splitter 3 that is a light branching device; disk 4 provided with pin holes as apertures (called “pin hole disk”); objective lens 5; sample 6; relay lens 7; detector 8; and motor 9 that rotates micro lens disk 2 and pin hole disk 4 synchronously.

Output light from laser 1 is made incident on micro lens disk 2 and is focused on each pin hole of pin hole disk 4, through beam splitter 3 by each micro lens provided on micro lens disk 2. Each light beam that passes through each pin hole on pin hole disk 4 is made incident on sample 6 via objective lens 5. The return light beams, such as reflected light beams from sample 6, are again made incident on pin hole disk 4 via objective lens 5. Light beams passing through each pin hole in pin hole disk 4 are reflected by beam splitter 3 and are made incident on detector 8 via relay lens 7. Micro lens disk 2 and pin hole disk 4 are fixed to a common shaft and are rotated synchronously by motor 9 attached to the shaft.

Operation of the scanner of FIG. 1 is as follows. The output light from laser 1 scans the surface of sample 6 by passing through each micro lens in micro lens disk 2, and each pin hole in pin hole disk 4, which are rotated synchronously. The reflected light from sample 6 is detected by detector 8 to obtain a confocal image. In addition, as mentioned above, each micro lens, provided in micro lens disk 2, focuses incident light on each pin hole of pin hole disk 4 via beam splitter 3.

The utilization efficiency of incident light is improved by arranging each pin hole at the position of the focal point of each micro lens.

However, for the micro lens disk 2 used in the conventional confocal scanner, such as shown in FIG. 1, the efficiency of light utilization is low because of the relationship between the micro lens diameter and the micro lenses. For example, in FIG. 2, which is a top view of a part of the micro lenses in micro lens disk 2, if the ratio of micro lens diameter to the micro lens, designation by symbols “D001” and “P001”, respectively, is 1:10, only about 1% of the light made incident on micro lens disk 2 is actually used.

For example, since the micro lens in micro lens disk 2 is circular, even if the micro lens is extended, unit it abuts the adjacent square, as shown in FIG. 3, the micro lens can utilize only an area of π/4 assuming that the area of the square is 1. That is, in the prior art, there is a problem that the light made incident on the shaded part of cannot be actually used and hence the light utilization efficiency of only about 78.5% (=π/4) is obtained.

In addition, since the beam diameter stopped by a micro lens is determined by the numerical aperture of the micro lens, there is another problem. That is, if the numerical aperture is small, the beam diameter cannot be sufficiently stopped.

### SUMMARY OF THE INVENTION

Accordingly, an object of the invention is to overcome the afore-mentioned and other deficiencies and disadvantages of the prior art.

Another object is to provide a confocal scanner which has a greatly improved efficiency of light utilization.

### BRIEF DESCRIPTION OF THE DRAWINGS

FIG. 1 is a block diagram depicting an exemplary conventional confocal scanner.

FIG. 2 is a top view depicting a part of the micro lenses in a micro lens disk.

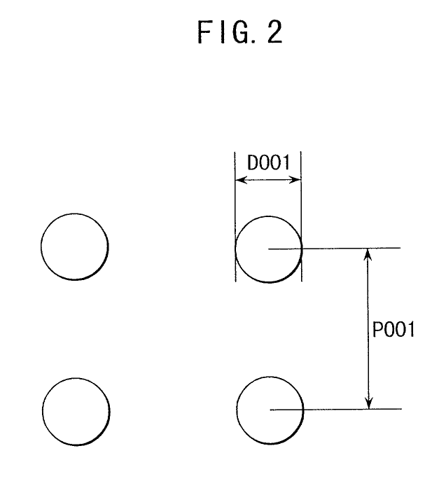

FIG. 3 is a top view also depicting a part of the micro lenses in a micro lens disk.

FIG. 4 is a block diagram depicting an illustrative embodiment of the invention.

FIGS. 5(A) and 5(B) are top views depicting a part of the micro lenses in a micro lens disk; wherein FIG. 5(A) shows an arrangement similar to FIG. 3; and FIG. 5(B) shows an arrangement of the invention.

FIG. 6 is a top view depicting a part of the micro lens disk in which triangular micro lenses are used.

FIG. 7 is a top view depicting a part of the micro lens disk in which regular hexagonal micro lenses are used.

FIG. 8 is a top view depicting a part of the micro lens disk in which a combination of two or more different shapes are used.

### DETAILED DESCRIPTION OF THE PREFERRED EMBODIMENTS

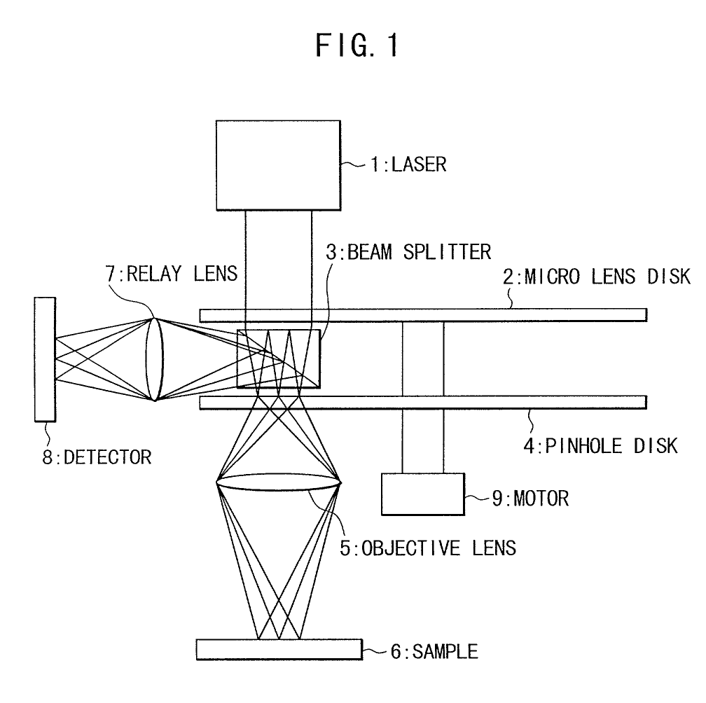

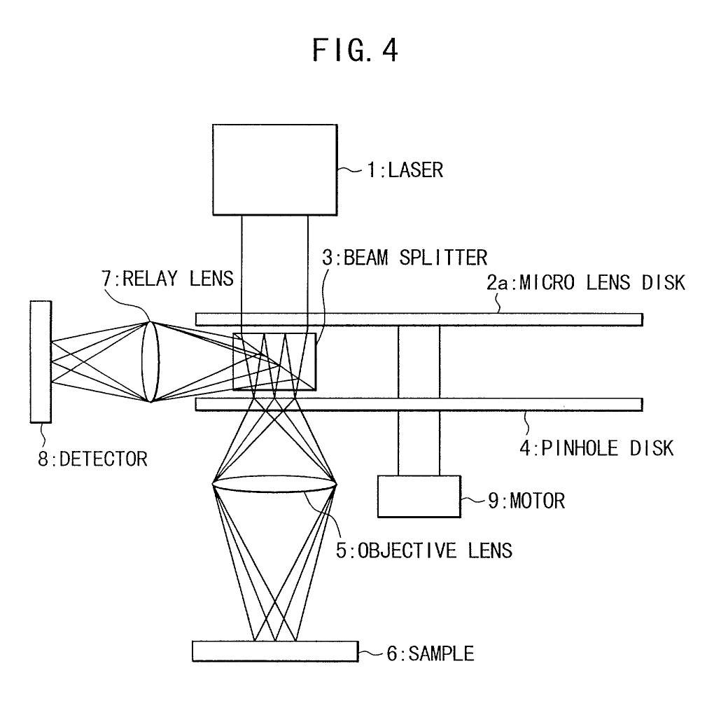

FIG. 4 shows an embodiment of the invention, wherein identification numbers 1 and 3-9 are used to depict the same components as shown in FIG. 1; and wherein micro lens disk 2a is provided with micro lenses which are used as the focusing means, in place of micro lens disk 2 of FIG. 1. The micro lenses used in the micro lens disk 2a are of different shapes than the circular shapes of the FIG. 1 device and are arranged with respect to each other in the manner to be discussed hereinbelow.

Output light beams from laser 1 are made incident on micro lens disk 2a and are focused on each pin hole of pin hole disk 4, through each micro lens provided in micro lens disk 2a, via beam splitter 3. Light beams passing through each pin hole in pin hole disk 4 are made incident on sample 6 via objective lens 5. The return light beams including reflected light from sample 6 are again made incident on pin hole disk 4 via objective lens 5. The light beams passing through each pin hole in pin hole disk 4 are reflected by beam spitter 3 and made incident on detector 8 via relay lens 7. Micro lens disk 2a and pin hole disk 4 are fixed to the same or common shaft and are rotated synchronously by motor 9 connected to the shaft.

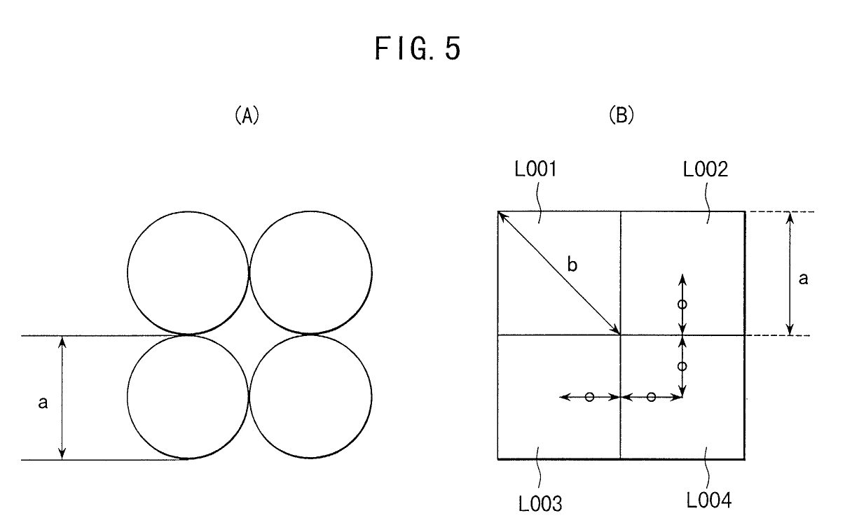

Operation of the embodiment of FIG. 4 will now be described with reference to FIGS. 5(A) and 5(B), wherein FIG. 5(A) is a top view showing conventional circular micro lenses; and FIG. 5(B) is a top view showing the case where square micro lenses of the invention are used, and arranged in the manner to be discussed. In FIG. 5(B), each micro lens shown with L001, L002, L003, and L004, has square shape is arranged so that the border lines of adjacent micro lenses pass the bisected points of the line segments connecting the center points of the adjacent micro lenses.

In this case, let the diameter of the circular micro lens be “a” and let the length of one side of the square lens also be “a” equal to the above and the diagonal of the square micro lens “b”. Then, the following relation holds:

b=2½×a (1)

Since this means that the size of the aperture increases by 2½ compared with that of the circular aperture, the numerical aperture of the square micro lens also becomes large and the diameter of the stopped beam becomes thin. This means that the beam diameter can be stopped thinner than in conventional scanners. Thus, light beams that pass through the pin holes in pin hole disk 4 increase.

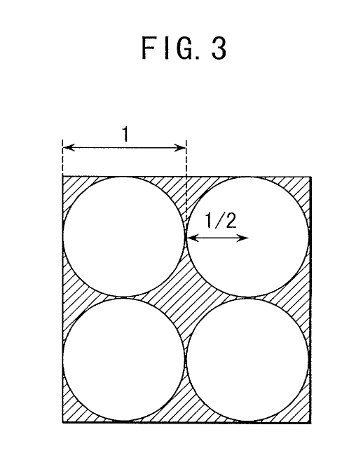

In addition, since the portions that cannot actually use the light incident to the micro lens disk, as shown by the shaded parts of FIG. 3 do not exist between adjacent micro lenses, in the invention, 100% utilization of the incident light is attained.

As a result, advantageously, with the invention, utilization efficiencies of 100% for the light incident on the micro lens disk 2a are attained. This is attained by using micro lenses of rectangular shape, in this case and in other cases of non-circular shapes, and by arranging the micro lenses so that the border lines thereof pass the bisected points of line segments connecting the center points of each two adjacent micro lenses.

Furthermore, although the micro lenses of square shapes are used in the embodiment of FIG. 5(B), micro lenses having triangular, rectangular, or hexagonal shapes can also be arranged so that the border lines thereof between two adjacent micro lenses pass the bisected points of the line segments connecting adjacent micro lenses. Thus, advantageously, with the other shapes, it is also possible to attain 100% utilization of the incident light on the micro lens disk 2a.

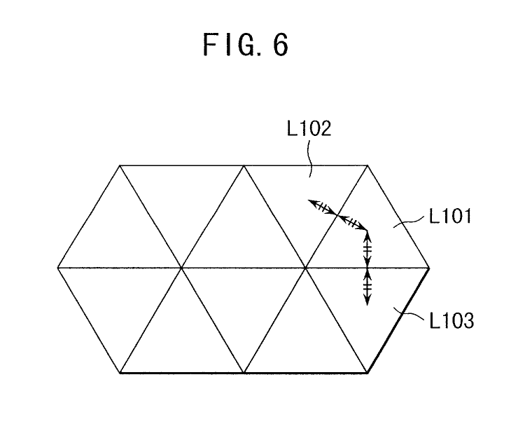

FIG. 6 shows a part of the micro lens disk 2a in which micro lenses of triangular shape are arranged, where each micro lens shown with designations L101, L102, L103 has the shape of an equilateral triangle and is arranged so that the border lines thereof pass the bisected points of line segments connecting the center points of each to adjacent micro lenses.

As shown in FIG. 6, advantageously, since there are no parts where the light incident on the micro lens disk 2a can not be utilized between the micro lenses as shown by the shaded parts of FIG. 3, the embodiment of the invention attains 100% utilization of the incident light.

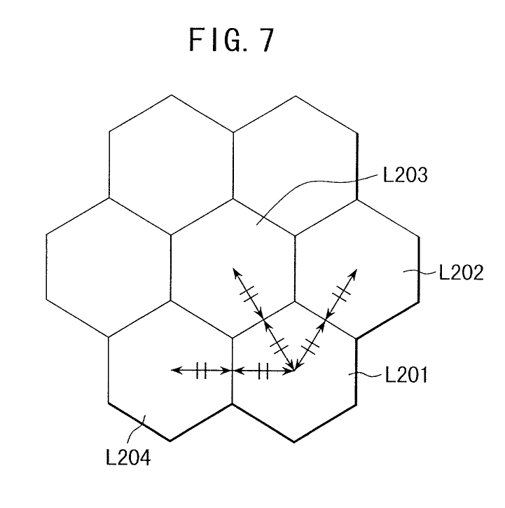

FIG. 7 shows a part of the micro lens disk 2a, in which micro lenses having a hexagonal shape are arranged, wherein each micro lens having the designation L201, L202, L203 and L204 has a regular hexagonal shape and is arranged so that the border lines thereof pass the bisected points of line segnments connecting the center points of each two adjacent micro lenses.

Thus, advantageously, as shown in FIG. 7, since there are no parts where the light incident on the micro lense disk 2a cannot be utilized between the micro lenses as shown by the shaded parts of of FIG. 3, the invention attains 100% utilization of the incident light.

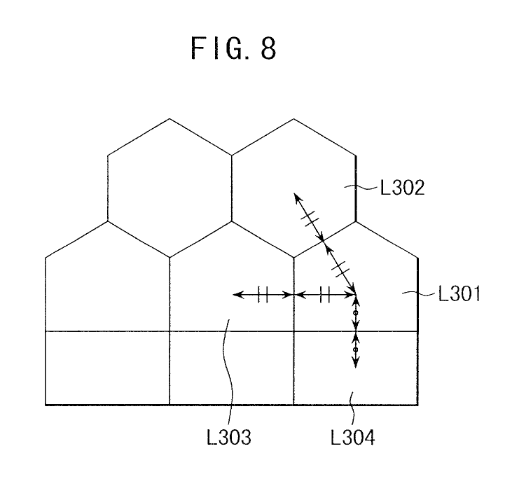

Furthermore, all of the micro lenses in the same disk are not limited in use to the same shape of the micro lenses. For example, a combination of micro lenses having two or more different shapes, such as shown in FIG. 8, may also be used FIG. 8 shows a part of the micro lens disk, on which micro lenses having two or more types of shapes are arranged. In FIG. 8, designations L301 and L303 show micro lenses of pentagonal shape; designation L302 shows a micro lens of hexagonal shape, and designation L304 shows a micro lens of rectangular shape, respectively. The micro lenses are arranged so that each border line thereof passes each bisected point of line segments connecting the center points of each two adjacent micro lenses.

Advantageously, as shown in FIG. 8, since there are no parts where the light incident on the micro lens disk 2a cannot be utilized between the micro lenses as shown by the shaded parts in FIG. 3, the utilization factor for the incident light is 100%.

In all of the foregoing embodiments, the invention confocal scanner improves the efficiency of incident light utilization.

The foregoing description is illustrative of the principles of the invention. Numerous modfications and extensions thereof would be apparent to the worker skilled in the art. All such modifications and extensions are to be considered to be within the spirit and scope of the invention.

What is claimed is:

1. In a confocal scanner comprising:
a first disk comprising a plurality of focusing means therein;
a second disk comprising a plurality of apertures in the same pattern as that of said focusing means;
means for synchronously rotating said first disk and said second disk; and
means for focusing light beams through said focusing means and said apertures; the improvemetn comprising:
means for arranging said plurality of focusing means so that each border line between said plurality of focusing means passes each bisected point of line segments connecting center points of each two adjacent said focusing means.

2. The scanner of claim 1, wherein shape of each of said plurality of focusing means is rectangular.

3. The scanner of claim 2, wherein said rectangle is a square.

4. The scanner of claim 1, wherein shape of each of said plurality of focusing means is triangular.

5. The scanner of claim 1, wherein shape of each of said plurality of focusing means is hexagonal.

6. The scanner of claim 1, wherein said plurality of focusing means comprises a combination of focusing means having different shapes.
